(19) United States
(12) Patent Application Publication
(10) Pub. No.: US 2008/0138496 A1
(43) Pub. Date: Jun. 12, 2008

(54) Preparation of Smoke Extract

(76) Inventor: Kim Plaschke, Naestved (DK)

Correspondence Address: CANTOR COLBURN, LLP, 20 Church Street, 22nd Floor, Hartford, CT, 06103, US

(21) Appl. No.: 11/628,524

(22) PCT Filed: Jun. 1, 2005
(86) PCT No.: PCT/DK05/00361

§ 371 Date: Sep. 4, 2007

(30) Foreign Application Priority Data
Jun. 4, 2004 (DK) PA 2004 00875
Jun. 4, 2004 (DK) PA 2004-00887

(51) Int. Cl. A23L 1/221

(52) U.S. Cl. 426/650

(57) ABSTRACT

A method for preparation of smoke extract from wood tar for flavouring and colouring of food products is disclosed. The smoke extract is with the present method produced by means of supercritical extraction of fractions of the wood tar. The extractions solvent, such as carbon dioxide, has very good properties of entraining and resolving the required fractions of the wood tar, and it is relatively simple to separate the resolved components in the retrieving process, as the different components have different solubility at different supercritical and subcritical conditions. Thus, a smoke extract containing less than 10 ppb (parts per billion) of benzo (a) pyrene and less than 20 ppb of benzo (a) athracene may be obtained. In one embodiment, the wood tar is subject to a separation process prior to the supercritical extraction to remove a substantial part of the unwanted components.

The present invention relates to the preparation of smoke extract for flavouring and colouring of food products

### BACKGROUND

Smoking of food products for preservation as well as flavouring of the food products is a very old and well known practice, in which the food products are subjected to the smoke from an combustion of wood, in which the gasses given off from the wood are not completely combusted due to lack of sufficient oxygen or due to the temperature of the combustion process. Thus, the smoke contains a vast number of substances, which provide the food products with the required features.

It is preferred for a number of food products to obtain the flavouring of smoking without subjecting the product to the traditional smoking process, and for that purpose, various types of smoke extracts have been developed.

In U.S. Pat. No. 3,106,473, a method of preparing a liquid smoke extract is disclosed, in which water is passed counter current with wood smoke to extract the water soluble parts of the smoke for use as a aqueous wood smoke flavoured solution. In the same document, the use of water-soluble fractions of the product of distillation of wood or from condensed smoke from a partly combustion of wood as a liquid smoke extract is discussed as well.

When heated with no or an insufficient amount of oxygen present for a complete combustion, e.g. distillation or pyrolysis, wood produces gasses which comprises water, water soluble components and water insoluble components, the latter is known as wood tar. The remains from the process are ashes and char, which mainly comprise carbon and some heavy tar components. However, the product known as wood tar obtained by condensation of the smoke may comprise some water-soluble components in addition to the insoluble components.

The water soluble components constitutes only a minor part of the products from the pyrolysis process of the wood, and attempts have been made to extract a suitable liquid smoke product for preparation of food products from other products of the pyrolysis process.

In WO 02/00040, a pyrolysis process is performed on wood and the wood char produced is subjected to an extraction process by means of an extraction solvent in its supercritical state. The supercritical solvent has excellent properties for entraining into the char and extract components thereof, which are regained by lowering the pressure of the supercritical solvent.

The wood tar constitutes the largest part of the products from the pyrolysis process of wood, but is generally regarded as being unsuitable for food products as it contains large amounts of carcinogenic compounds, in particular polynuclear aromatic hydrocarbons (PAH) such as benzo (a) pyrene and benzo (a) athracene.

Attempts to obtain a suitable liquid smoke from the tar have been made, and one is disclosed in U.S. Pat. No. 5,681,603, in which the wood tar is dissolved in an aqueous alkali solution, which is contacted with a non-ionic, aromatic hydrocarbon based resin to remove the polynuclear aromatic compounds. However, the process requires the disposal or regeneration of the resin and is therefore a complex process, which furthermore requires a detail control and supervision of the quality of the produced liquid smoke as the contents of the wood and the produced wood tar are known to have large natural variations.

Another method is disclosed in U.S. Pat. No. 4,154,866, in which the wood tar is mixed with propylene glycol, heated to about 140° C. and distilled by lowering the pressure to about 100 mmHg, whereby the propylene glycol and a part of the wood tar is vaporised. After a condensation of the vapour, a treatment of the condensate by means of powdered activated carbon is required to produce a mixture of propylene glycol and wood tar fractions that comprises “no detectable amounts of 3,4-benzopyrene”.

The object of the present invention is to provide a method for the production of a smoke extract for flavouring and colouring of food products, which does not have the above-mentioned drawbacks, and which method may be applied to produce smoke extract in industrial quantities with a safe, low level of PAH.

Wood tar is in general considered to be unsuitable for food products due to its high content of PAH and components, which may cause a bitter or burned taste, but it has by the present inventor been found, that a supercritical extraction process similar to the one disclosed in WO 02/00040 actually may be used on the wood tar instead of on the char and produce a high quality smoke extract, which is low in PAH and which may be produced in large quantities without introducing chemicals into the process, which could give rise to new safety concerns for the consumer of the food products treated with the smoke extract.

The object is obtained by the method according to the present invention, in which the smoke extract is produced by means of supercritical extraction of fractions of the wood tar. The extractions solvent, such as carbon dioxide, has very good properties of entraining and resolving the required fractions of the wood tar, and it is relatively simple to separate the resolved components in the retrieving process, as the different components have different solubility at different supercritical and subcritical conditions. Thus, a smoke extract containing less than 10 ppb (parts per billion) of benzo (a) pyrene and less than 20 ppb of benzo (a) athracene may be obtained.

In a particularly preferred embodiment, the wood tar has been subject to a separation process prior to the supercritical extraction to remove a substantial part of the unwanted components, whereby the viscosity of the wood tar for the supercritical extraction process may be lowered considerably and the wood tar will be much less sticky, which provides for an easier conductance of the supercritical extraction process. Also, the supercritical extraction process may be performed with less surveillance of the quality of the retrieved fractions with respect to the contents of PAH and possibly other unwanted components, such as heavy metals

These and other advantages of the method according to the present invention and preferred embodiments thereof will be apparent from the following description of the present invention.

### BRIEF DESCRIPTION OF THE INVENTION

Thus, the present invention relates to a method of preparing a smoke extract for flavouring of food products comprising an extraction process involving
extracting one or more fractions of a wood tar with an extraction solvent substantially in its supercritical state, and retrieving at least some of the extracted fraction or fractions of the wood tar to thereby obtain a smoke extract.

By the term wood tar is understood a tar obtained from wood and mainly comprising components, which are substantially insoluble in water, although a minor part of water-soluble components may be present as well.

The extraction solvent is preferably selected from the group consisting of carbon dioxide, methane, ethane, propane, ethylene, propylene, ammonia, methanol, water and mixtures of one or more of these solvents. However, other extraction solvents may be applied within the scope of the present invention, preferably those having a critical temperature and pressure in the range of 1 to 400° C. and 20 to 500 bars respectively may be applied as extraction solvent.

The wood from which the tar has been obtained may preferably be selected from the group consisting of oak, spruce, pine, beech, cherry, mahogany, ash, maple, alder, elm, birch, hickory and poplar. In principle all kinds of wood may be suitable according to the invention and the choice between different woods is merely a matter of manipulating the taste of the prepared smoke extract. Specific examples of wood, from which the wood tar may preferably be obtained, are maple tree (Acer negundo L.), White birch (Betula pendula Roth—with ssp. B. alba L. and B. verrucosa Ehrh), European birch (Betula pubescens Ehrh), hornbeam (Carpinus betulus L.), hickory (Carya ovata (Mill.) Koch (C. alba (L.). Nutt.)), chestnut tree (Castanea sativa Mill.), eucalyptus (Eucalyptus sp.), beech (Fagus grandifolia Ehrh. and Fagus sylvatica L.), common ash (Fraxinus excelsior L), walnut tree (Junglans regia L.), apple (Malus pumila Mill.), mesquite wood (Prosopis juliflora DC.), cherry tree (Prunus avium L.), white oak (Quercus alba L.), evergreen oak (Querqus ilex L.), common red oak (Quercus robur L.), alder buckthorn (Rhamnus frangula L.), black locust (Robinia pseudoacacia), sweet elm (Ulmus fulva Michx) and elm (Ulmus rubra Mühlenb.).

The extraction process cycle comprises in a preferred embodiment of the present invention the steps of
a) supplying a portion of wood tar into a reaction container,
b) supplying a portion of extraction solvent into the reaction container,
c) allowing the extraction solvent in its supercritical state to act on the wood tar for a given contact time so as to extract one or more fractions of the wood tar,
d) leading the extraction solvent and the extracted wood tar components from the reaction container into a second chamber, while the un-extracted parts of the wood tar remain in the reaction container, and
e) reducing the pressure in the second chamber to condense at least one of the extracted tar fractions from the extraction solvent, thereby retrieving the components forming said smoke extract.

The temperature and/or pressure within the reaction container may be controlled during the process to keep the extraction solvent in a substantially supercritical state for a given contact time so as to extract one or more fractions of the wood tar.

The above extraction process may be carried out as a batch process, wherein the extraction solvent is kept in a substantially supercritical state within the reaction container for a given contact time so as to extract one or more fractions of the wood tar. The reaction container should be suitable for sustaining the high pressure of the supercritical extraction solvent, such as 250 bars.

The extraction solvent is in a batch process provided into the reaction container until a pressure within the container is build up to the supercritical pressure, the solvent in its supercritical state is allowed to react with the wood tar for a preset contact time and is then removed from the reaction container, where the pressure typically drops below the supercritical level for that solvent. The steps b) to e) of the extraction cycle may be repeated one or more times to extract more fractions of the wood tar until substantially all useful fractions for the intended purpose are extracted, and the extraction solvent may be recycled when the extracted tar fractions have been removed there from.

The reaction container may be equipped with cooling and/or heating means in order to control the temperature of the content of the reactor container during the contact time.

The portion of wood tar fed into the reaction container should preferably occupy preferably 40% or less, more preferably 30% or less and most preferably 20% or less of the interior volume of the reaction container, so as to ensure sufficient contact area between the wood tar and the solvent for an efficient extraction to take place.

Alternatively, the extraction may be carried out as a continuous process. In particularly, such continuous extraction process cycle may comprise the steps of
a) supplying a portion of wood tar into a reaction container,
b) providing a continuous flow of extraction solvent in a substantially supercritical state through the reaction container to facilitate contact between the extraction solvent and the wood tar, so as to extract one or more fractions of the wood tar,
c) continuously leading a flow of extraction solvent comprising the extracted wood tar fractions from the reaction container and into a second chamber, while the un-extracted parts of wood tar remain in the reaction container,
d) reducing the pressure in the second chamber to condense at least one of the extracted tar fractions from the extraction solvent, thereby retrieving the components forming said smoke extract, and
e) maintaining the flow of extraction solvent through the reaction container for a sufficient time to extract a measurable fraction of the wood tar.

The wood tar may be supplied into the reaction container batch wise, so that an amount of wood tar is situated in the reaction container and the continuous flow of extraction solvent in the supercritical state is maintained until all of or substantially all of the fractions of the tar which are useful for the present purpose are extracted, where after the remaining wood tar is replaced with a new amount, or the wood tar within the reaction container may be supplied continuous to the container and a remaining part of the tar may be removed continuously as well.

The extracted wood tar fractions are in a preferred embodiment of the present invention retrieved by stepwise reduction of the pressure in said second chamber, which in this case may consist of a plurality of chambers forming a cascade, where the extraction solvent is supplied from the reaction container into one chamber and there from to the subsequent chamber etc., where the pressure is lowered for each subsequent chamber. A part of the extracted wood tar is condensed at each step of the pressure reduction, e.g. two, three or four steps.

Some of the extracted wood tar is condensed in each step of pressure reduction, and the condensed wood tar in each step of pressure reduction may be collected separately to obtain one or more fractions of extracted wood tar. Using different combinations of the obtained fractions may thereafter provide aromatics having different smoke taste, flavour and colour. In particular tends the unwanted carcinogenic compounds, in particular the PAH to condense at particular pressure steps and the contents thereof in the obtained smoke extract may in this manner be reduced.

The steps of retrieving the components forming the smoke extract from the extraction solvent are well known to the skilled person and suitable examples are e.g. given in WO 02/00040.

The wood tar may prior to the contact with the extraction solvent be brought to a temperature close to the temperature of the applied extraction solvent, preferably within 30° C. of said temperature, most preferred within 20° C. of said temperature, so that the temperature of the extraction solvent will not drop to below the supercritical phase at contact with the wood tar.

The wood tar may advantageously be diluted or suspended in a solvent or suspending agent prior to the extraction process. Among the different purposes for mixing the wood tar with a solvent or suspending agent are the following: Protection of the equipment, extraction of a larger part of the high molecular weight components in the wood tar and adjusting the transport time when a counter current extraction process is applied. Optionally, inorganic acidic or basic components may be added as well. In one aspect the purpose of diluting or suspending the wood tar is to protect the equipment from adherence of wood tar. Otherwise low water content in the wood tar may cause the tar to adhere and stick to the equipment. In order to avoid this the wood tar is preferably diluted or suspended to an average wood tar concentration in the range of 10 to 95% by weight, preferably 20 to 80% by weight, more preferably 40 to 80% by weight and most preferably 50 to 75% by weight. In a second aspect the purpose of diluting or suspending the wood tar is to adjust the transport time for the wood tar, when the extraction is carried out in a counter current process. The transport time is reduced by addition of higher amounts of solvent or suspending agent.

In general, the solvent or suspending agent should be non-toxic to humans since some of the solvent or suspending agent may be extracted by the extraction solvent, and thus will be present in the final product. Suitable solvent or suspending agents for the two abovementioned purposes may preferably be selected from the group consisting of vegetable oils, animal oils, ethanol, water or mixtures thereof.

In a third aspect the solvent or suspending agent is an enhancer for the extraction of fractions from the wood tar. In the present context an enhancer is defined as a component, which improves the ability of supercritical solvents to extract high molecular components from the wood tar. The enhancers according to the present invention are preferably selected from the group consisting of methanol, ethanol, water or mixtures thereof. Enhancers are either added prior to the extraction process or injected separately into the reactor wherein the extraction takes place. The amount of enhancer is preferably at least 0.1% v/v of the wood tar and more preferably at least 1% v/v. In general, there is no upper limit as the effect will not increase further when the enhancer is added in an amount exceeding more than about 5% v/v of the wood tar.

Additionally or alternatively, the wood tar may be admixed with a carrier prior to the extraction process, before or after being supplied into the reaction container. The use of a carrier may reduce the necessary contacting time in the extraction. The carrier is preferably substantially non-soluble in the extraction solvent in its supercritical state. The carrier is preferably selected from the group consisting of diatomite, celite, bentonite, perlite or mixtures thereof. However, in principle, any type of carrier may be used. The volumetric ratio between wood tar and carrier is advantageously within the range of 1:0.1 and 1:10, preferably 1:0.5 to 1:2.

The extraction solvent comprises in a preferred embodiment carbon dioxide in an amount of at least 85% by weight, preferably at least 90% by weight and more preferably at least 95% by weight. The remaining part of the extraction solvent may be water, or the carbon dioxide may substantially constitute about 100% by weight of the extraction solvent.

The temperature of the extraction solvent is preferably maintained within the range of 20 to 100° C., preferably 30 to 70° C. and more preferably 40 to 60° C. during the extraction process, and is in a particularly preferred embodiment substantially maintained at about 50° C. during the extraction process. The pressure in the reaction container is maintained in the range of 75 to 500 bars, preferably 100 to 250 bars, and more preferably in the range of 120 to 180 bars, such as about 150 bars.

It has been found that the composition of the extracted smoke extract largely depends on the pressure during the extraction process, thus the taste and quality of the extracted product may be adjusted by modifying the pressure conditions of the extraction process.

The smoke extract at the end of the extraction process comprises in a preferred embodiment a fraction of the extracted wood tar that amounts to 1 to 60% by weight, preferably 5 to 40% by weight and more preferably 5 to 20% by weight of the wood tar, which has been fed into the reaction container. The reason to terminate the extraction process at this level is to avoid too high concentrations of carcinogenic and/or bitter tasting components in the smoke extract.

According to the present invention it should preferably be avoided to extract more than 60% by weight from the wood tar, which is fed into the process. The level of extraction, which is desirable, is determined by the concentration of unwanted carcinogenic and/or bitter tasting components in the smoke extract that forms during the process. Generally extending the level of extraction too far may cause the concentration of the unwanted components in the extraction product to exceed above the acceptable level.

The contact time between wood tar and extraction solvent is preferably within the range of 5 to 120 minutes, preferably 15 to 90 minutes and most preferably 20 to 60 minutes. The contacting time is an important factor in order to achieve a good quality of the extraction product. By keeping an optimal contacting time the amount of bitter and/or carcinogenic components is diminished, thus the taste and healthiness of the extracted fraction of wood tar is improved.

In a preferred embodiment, the wood tar is prepared by means of a separation process performed on a raw wood tar product before the conduction of the extraction of one or more fraction thereof for use as a smoke extract for food products.

The separation process performed on a raw wood tar product to obtain the wood tar on which the supercritical extraction process is performed may be conducted with a number of procedures known per se in the art, with the main purpose of producing a wood tar with a lower viscosity, possibly also a lower content of unwanted components, in particular of PAH and possibly of heavy metals. This separation process of one or more fractions of the raw wood tar may be performed by means of a liquid solvent, by means of which fractions of the raw tar are extracted and are retrieved again to thereby obtain the wood tar for the further extraction process. The solvent may be an oil or a substantially non-polar solvent or mixtures of these. The solvent may e.g. comprise alcohols, aldehydes or ketones, having at least two carbon atoms, alkanes, alkenes or alkynes, having at least five carbon atoms, ethers, esters, etc., but it is preferred that it is selected from the group consisting of ether, ethanol, propanol, butanol, diethyl ether, hexane, methyl acetate and any mixtures thereof.

Alternatively or additionally, the separation process performed on a raw wood tar product for the preparation of the wood tar may include separation of one or more fractions of the raw wood tar by means of a mechanical separation, such as centrifugation, so as to obtain the wood tar for the further extraction process.

The separation process performed on a raw wood tar product for the preparation of the wood tar may furthermore consist of or include distillation of the raw wood tar so as to obtain the wood tar from the distillate for the further extraction process. The distillation may in particular be performed in an arrangement comprising a plurality of condensation stations having different condensation temperatures and/or pressures, wherein a fraction of the distillate is collected at each condensation station, and the wood tar for the further extraction process comprises one or more of said fractions.

As a further alternative, which also may be applied together with any of the previous mentioned processes, the separation process performed on a raw wood tar product for the preparation of the wood tar may include separation of one or more fractions of the raw wood tar by means of electrophoresis so as to obtain the wood tar for the further extraction process.

### EXAMPLES OF EMBODIMENTS OF THE PRESENT INVENTION

The following examples of production of smoke extract for food products by means of supercritical extraction may be based on raw wood tar or on wood tar obtained from a separation process perform on a raw wood tar product, such as a wood tar separated from a raw wood tar product by means of a liquid extraction with the use of diethyl ether, followed by retrieving the extracted fractions to obtain a wood tar, which has a lower viscosity than the raw wood tar product.

A batch process according the present invention may be performed by mixing a portion of wood tar with a similar volume of diatomite and placing this mixture in a suitable reaction container, in which the mixture takes up about 40% of the internal volume of the container. The container is heated to 50° C. and this temperature is kept for 15 minutes to ensure that the mixture therein has reached approximately the same temperature. Carbon dioxide is then supplied from a reservoir to the container by means of a high-pressure pump. The pressure within the container is build up as the carbon dioxide is supplied, and the temperature of the container is in the beginning of the filling step regulated by heating means to keep the temperature about 50° C., whereas the compression of the carbon dioxide at the last part of the filling step causes increasing temperatures, and the container may be equipped with cooling means to be used to regulate the temperature at the end of the filing step, which ends when the pressure within the container reaches 150 bars and the temperature is about 50° C. A contact time of 30 minutes at these conditions is applied, where after the carbon dioxide with the extracted parts of the wood tar is allowed to flow to a second chamber, which consists of three containers connected in series. The flow is first directed to a first of these containers, where the pressure is lowered to about 100 bars and the temperature is allowed to drop to about 40° C. This causes a first condensation of extracted parts, which are collected from the container. The carbon dioxide with the remains of the extracted parts of the wood tar is then lead to the second and the third container of the second chamber, where the pressure is lowered to 80 bars and 55 bars, respectively, whereas the temperature by means of heating means is kept about 40° C., and a second and third condensate are collected from the respective containers. The carbon dioxide is then recycled to the reservoir. The extraction cycle is repeated three times in total for a given portion of wood tar, which is then removed from the reaction container together with the diatomite and replaced with a new mixture of wood tar and diatomite and the whole process may be repeated. The fractions condensed in the first and third container of the second chamber may be tested for their contents of PAH before they are released for the use as smoke extract, whereas the condensate from the second container most probably has a very low content of PAH.

In a continuous extraction process, the mixture of wood tar and diatomite is placed in an elongated column reactor being the reaction container, which is kept under pressure at 150 bars during the whole extraction process. Carbon dioxide is fed into an inlet at one end of the reactor, flows through the reactor so that the contact time with the mixture of wood tar and diatomite is between 20 and 40 minutes and out through an outlet at the other end of the reactor, form which it flows to a second chamber comprising a cascade of containers as discussed above with reference to the batch process. The carbon dioxide may be fed and removed batch-wise during the extraction process, in which the conditions of the extraction solvent within the container continuously is kept at supercritical conditions, or a constant flow of carbon dioxide may be provided.

In a further continuous extraction process, the mixture of wood tar and diatomite is diluted with an amount of ethanol of 4% of the volume of the wood tar and the mixture is fed into the column reactor by means of a high pressure pump, flows through the reactor in counter-flow or cross-flow with respect to a continuous flow of the carbon dioxide, and the remains of the mixture is removed from the column reactor after about 90 minutes of contact time with the flow of carbon dioxide in its supercritical state. The extracted fractions of the wood tar are retrieved as discussed above.

1. A method of preparing a smoke extract for flavoring of food products comprising an extraction process comprising:
extracting one or more fractions of a wood tar with an extraction solvent substantially in a supercritical state, and
retrieving at least some of the extracted fraction or fractions of the wood tar to thereby obtain a smoke extract.

2. A method according to claim 1, wherein the extraction solvent is selected from the group consisting of carbon dioxide, methane, ethane, propane, ethylene, propylene, ammonia, methanol, water and mixtures of one or more of these solvents.

3. A method according to claim 1, wherein the wood from which the tar has been obtained is selected from the group consisting of oak, spruce, pine, beech, cherry, mahogany, ash, maple, alder, elm, birch, hickory and poplar.

4. A method according to claim 1, wherein said extracting comprises:
a) supplying a portion of wood tar into a reaction container,
b) supplying a portion of extraction solvent into the reaction container,
c) allowing the extraction solvent in the supercritical state to act on the wood tar for a given contact time so as to extract one or more fractions of the wood tar,
d) leading the extraction solvent and extracted wood tar components from the reaction container into a second chamber, while un-extracted parts of the wood tar remain in the reaction container, and
e) reducing pressure in the second chamber to condense at least one of the extracted tar fractions from the extraction solvent, thereby retrieving the components forming said smoke extract.

5. A method according to claim 4, wherein the extraction is carried out as a batch process, and the extraction solvent is kept in a substantially supercritical state within the reaction container for a given contact time so as to extract one or more fractions of the wood tar.

6. A method according to claim 5, wherein the steps b) to e) of the extraction cycle are repeated at least one time to extract more fractions of the wood tar.

7. A method according to claim 6, wherein the extraction solvent following each extraction cycle is reused in the extraction process.

8. A method according to claims 4, wherein the portion of wood tar fed into the reaction container occupies preferably 40% or less of an interior volume of the reaction container.

9. A method according claims 1, wherein the extraction is carried out as a continuous process.

10. A method according to claim 9, wherein the continuous extraction process cycle comprises:
a) supplying a portion of wood tar into a reaction container,
b) providing a continuous flow of extraction solvent in a substantially supercritical state through the reaction container to facilitate contact between the extraction solvent and the wood tar, so as to extract one or more fractions of the wood tar,
c) continuously leading a flow of extraction solvent comprising the extracted wood tar fractions from the reaction container and into a second chamber, while un-extracted parts of wood tar remain in the reaction container,
d) reducing pressure in the second chamber to condense at least one of the extracted tar fractions from the extraction solvent, thereby retrieving the components forming said smoke extract, and
e) maintaining the flow of extraction solvent through the reaction container for a sufficient time to extract a measurable fraction of the wood tar.

11. A method according to claim 4, wherein the extracted wood tar fractions are retrieved by stepwise reduction of the pressure in said second chamber, wherein a part of the extracted wood tar is condensed at each step of the pressure reduction.

12. A method according to claim 4, wherein the wood tar prior to contracting the extraction solvent is brought to a temperature close to a temperature of the applied extraction solvent, substantially within about 30° C. of said temperature.

13. A method according to claim 1, wherein the wood tar is diluted or suspended in a solvent or suspending agent prior to the extraction process.

14. A method according to claim 1, wherein the wood tar is admixed with a carrier prior to the extraction process.

15. A method according to claim 14, wherein the carrier is substantially non-soluble in the extraction solvent in its supercritical state.

16. A method according to claim 15, wherein the carrier is selected from the group consisting of diatomite, celite, bentonite, perlite and mixtures thereof.

17. A method according to claim 14, wherein a volumetric ratio between wood tar and carrier is in the range of 1:0.1 and 1:10.

18. A method according to claim 1, wherein the extraction solvent comprises carbon dioxide in an amount of at least 85% by weight.

19. A method according to claim 1, wherein a temperature of the extraction solvent is maintained within the range of 20 to 100° C. during the extraction process.

20. A method according to claim 4, wherein the pressure in the reaction container is maintained within the range of 75 to 500 bars.

21. A method according to claim 1, wherein the smoke extract at the end of the extraction process comprises a fraction of the extracted wood tar that amounts to 1 to 60% by weight of the wood tar which has been fed into the reaction container.

22. A method according to claim 1, wherein contact time between wood tar and extraction solvent is within the range of 5 to 120 minutes.

23. A method according to claim 1, wherein said wood tar is prepared by means of a separation process performed on a raw wood tar product.

24. A method according to claim 23, wherein the separation process performed on a raw wood tar product for the preparation of the wood tar includes
extraction of one or more fractions of the raw wood tar by means of a liquid solvent, and
retrieving the extracted fractions of the raw wood tar to thereby obtain the wood tar for the further extraction process.

25. A method according to claim 24, wherein the liquid solvent is a substantially non-polar solvent.

26. A method according to claim 25, wherein the liquid solvent is selected from the group consisting of ether, ethanol, propanol, butanol, diethyl ether, hexane, methyl acetate and any mixtures thereof.

27. A method according to claim 23, wherein the separation process performed on a raw wood tar product for the preparation of the wood tar includes
separation of one or more fractions of the raw wood tar by means of a mechanical separation so as to obtain the wood tar for the further extraction process.

28. A method according to claim 23, wherein the separation process performed on a raw wood tar product for the preparation of the wood tar includes
distillation of the raw wood tar so as to obtain the wood tar from the distillate for the further extraction process.

29. A method according to claim 28, wherein the distillation comprises a plurality of condensation steps at different condensation temperatures and/or pressures, wherein a fraction of the distillate is collected at each condensation step, and the wood tar for the further extraction process comprises one or more of said fractions.

30. A method according to claim 23, wherein the separation process performed on a raw wood tar product for the preparation of the wood tar includes
separation of one or more fractions of the raw wood tar by means of electrophoresis so as to obtain the wood tar for the further extraction process.

31. A method according to claim 10, wherein the extracted wood tar fractions are retrieved by stepwise reduction of the pressure in said second chamber, wherein a part of the extracted wood tar is condensed at each step of the pressure reduction.

32. A method according to claim 11, wherein the wood tar prior to contacting the extraction solvent is brought to a temperature close to a temperature of the applied extraction solvent, substantially within about 30° C. of said temperature.

33. A method according to claim 10, wherein the pressure in the reaction container is maintained within the range of 75 to 500 bars.
